(19) United States
(12) Patent Application Publication
(10) Pub. No.: US 2013/0188647 A1
(43) Pub. Date: Jul. 25, 2013

(54) COMPUTER SYSTEM FABRIC SWITCH HAVING A BLIND ROUTE

(71) Applicants: Russ W. Herrell, Fort Collins, CO (US); Gregg B. Lesartre, Fort Collins, CO (US)

(72) Inventors: Russ W. Herrell, Fort Collins, CO (US); Gregg B. Lesartre, Fort Collins, CO (US)

(21) Appl. No.: 13/824,457

(22) PCT Filed: Oct. 29, 2010
(86) PCT No.: PCT/US10/54629

§ 371 Date: Mar. 18, 2013

(51) Int. Cl. H04L 12/56

(52) U.S. Cl. CPC H04L 45/74
USPC 370/392

(57) ABSTRACT

A fabric switch includes ports, a blind route determination function component, a location function component, and a routing function component. Packets are received and forwarded via the ports. The blind route determination function component determines whether a port at which a packet is received is configured for a blind route, the location function component provides for determining a location of routing information within the packet based at least in part on the input port at which the packet was received if a blind route is not defined for the port. The routing function component provides for determining an output port as a routing function based at least in part on the contents of the location, or the existence of a blind route.

### BACKGROUND

Separate computer nodes can function together as a single computer system by communicating with each other over a fast computer system fabric. For example, a blade system can include a chassis and blades installed in the chassis. Each blade can include one or more processor nodes; each processor node can include one or more processors and associated memory. The chassis can include a fabric that connects the processor nodes so they can communicate with each other and access each other's memory so that the collective memory of the connected blades can operate coherently. Fabrics can be scaled up to include links that connect fabrics that connect blades. In such cases, there are often multiple routes between a communication's source and destination.

To route communication packets properly, a fabric can include one or more switches with multiple ports. Typically, a switch examines a portion of each received packet for information pertinent to routing, e.g., the packet's destination. The location of the portion of the packet header examined can vary according to the communication protocol used by the blade system. The switch then selects an output port based on the routing information.

### BRIEF DESCRIPTION OF THE DRAWINGS

FIG. 1 is a schematic diagram of a fabric switch in accordance with an example.

FIG. 2 is a flow chart of a fabric-switch process in accordance with an example.

FIG. 3 is a schematic diagram of a computer system in accordance with an example.

FIG. 4 is a flow chart or a process employed in the context of the computer system of FIG. 3.

FIG. 5 is a schematic diagram of another computer system employing fabric switches in accordance with an example.

### DETAILED DESCRIPTION

Examples relate to a fabric switch having ports, with the fabric switch having the ability to route packets of varying protocols based on routing information in the packets, and having the ability to route foreign packets based on blind routes established between ports of the fabric switch.

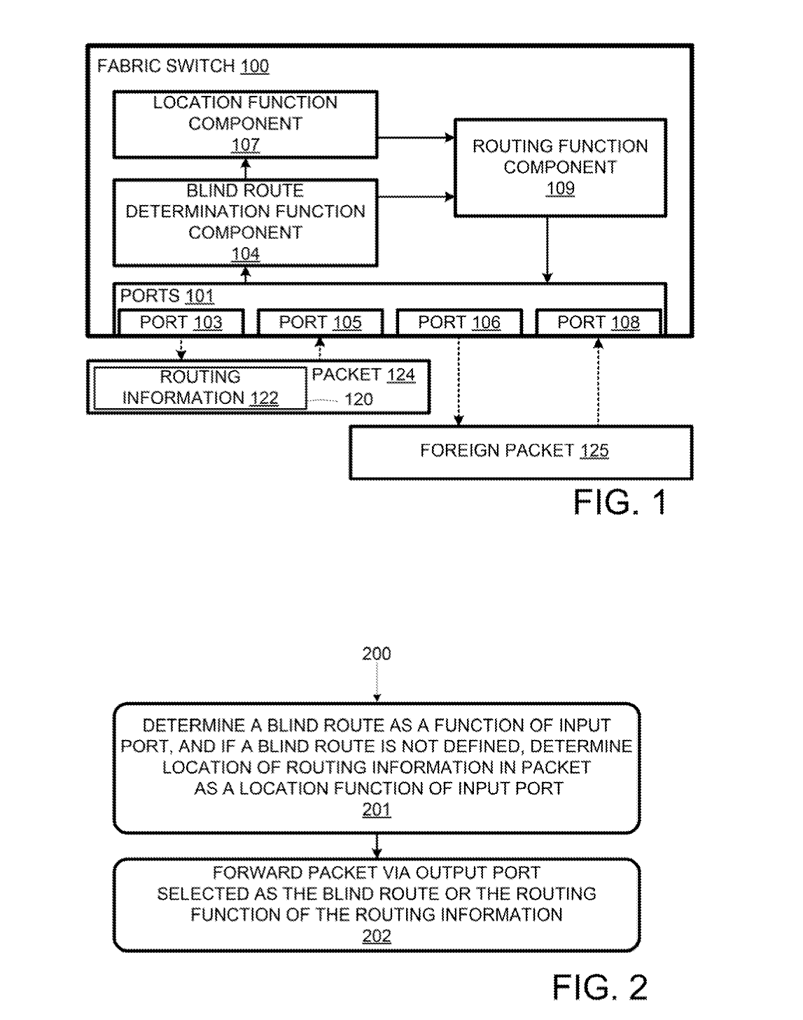

A fabric switch 100 includes ports 101, including ports 103, 105, 106, and 108, a blind route determination function component 104, a location function component 107, and a routing function component 109, as shown in FIG. 1. Fabric switch 100 implements a process 200 flow charted in FIG. 2. At process segment 201, the blind route determination function component 104 determines whether a blind route has been defined for the input port. If a blind route has not been defined, the location function component 107 determines a location 120 of routing information 122 in a packet 124 as a location function of the port 105 at which packet 124 was received, or determines a blind route through the fabric switch for foreign packet 125 based on the port 108 at which foreign packet 125 was received. At process segment 202, packet 124 is forwarded out a port 103 selected as a routing function (implemented by routing function component 109) of routing information 122, and foreign packet 125 is routed out port 106 based on a blind route established, from port 108 to port 106. Thus, process 200 allows proper routing determinations to be made despite the use of different protocols at respective real or virtual ports of a switch, and allows blind routes to be established between ports.

A blade computer system 300 includes a chassis 301, blades 303, including blades B1-B8, and a fabric module 305. Fabric module 305 includes at least portions of links 307, e.g., links L1-L8, and a fabric switch 310. Fabric switch 310 includes a processor 311, media 313 encoded with code 315, and ports 317, e.g., ports P1-P8. Code 315 is configured to, when executed by processor 311, define a database 319 and functionality for a link interface 320 of switch 310. Code 315 further serves to define a link interface 320 with an initialization manager 321 and a packet manager 323. Packet manager 327 includes a blind route function component 324, a location function component 325, and a routing function component 327. Database 319 includes an input table 331, an output table 333, environmental data 335, allocation, policies 337, and virtualization information 339. In another example, a processor external to a fabric switch executes software to configure the fabric switch to read the routing field of a packet or process blind routes, perform a conversion as appropriate, and lookup the output port.

Input table 331 uses input port identity as a key field. Associated with each input port identity is a blind route, an offset, a bit length, and a conversion function. If the blind route is populated, the offset, bit length, and conversion function are not populated. Conversely, if the offset, bit length, and conversion function are populated, the blind route is not populated. In input table 331, a blind route has been established between ports P2 and P8.

The offset and length define a routing field location, typically in the packet header, which bears routing information used to determine which output port through which to forward a packet. This location is protocol dependent.

In some cases, the value at the indicated location can be used directly as an index to output table 333. In other cases, some conversion function, identified in the rightmost column of table 331, can be applied to obtain the index value to be input to output table 333. For example, for input link identities L3 and L4, the extracted value is to be decremented by unity to yield the input to output table 331. For link identity L4, the source link identity value (e.g., 4) is added modulo-8 to the extracted value to determine the value to be input to table 333. For input link L5, four bits are extracted, but the third is ignored. The conversions are tied to the protocols employed by the input links.

In practice, the conversions can be performed using table look-ups. As explained further below, in some cases, the conversions may take into account environmental data, allocation policies, and virtualization information. Once the packet value is extracted/converted, it can be input to output table 333, which associates the packet value with an output port.

Note that the complexity associated with protocol dependencies, and virtual ports and channels (as discussed below) is avoided when a blind route is defined. Accordingly, designating blind routes for protocols and routes that only need simple input-to-output port mappings can conserve resources by reserving switch resources for protocols and routes that require more complex routing. Blind routes also allow the switch to accommodate future protocols which the switch may not support for protocol-based routing.

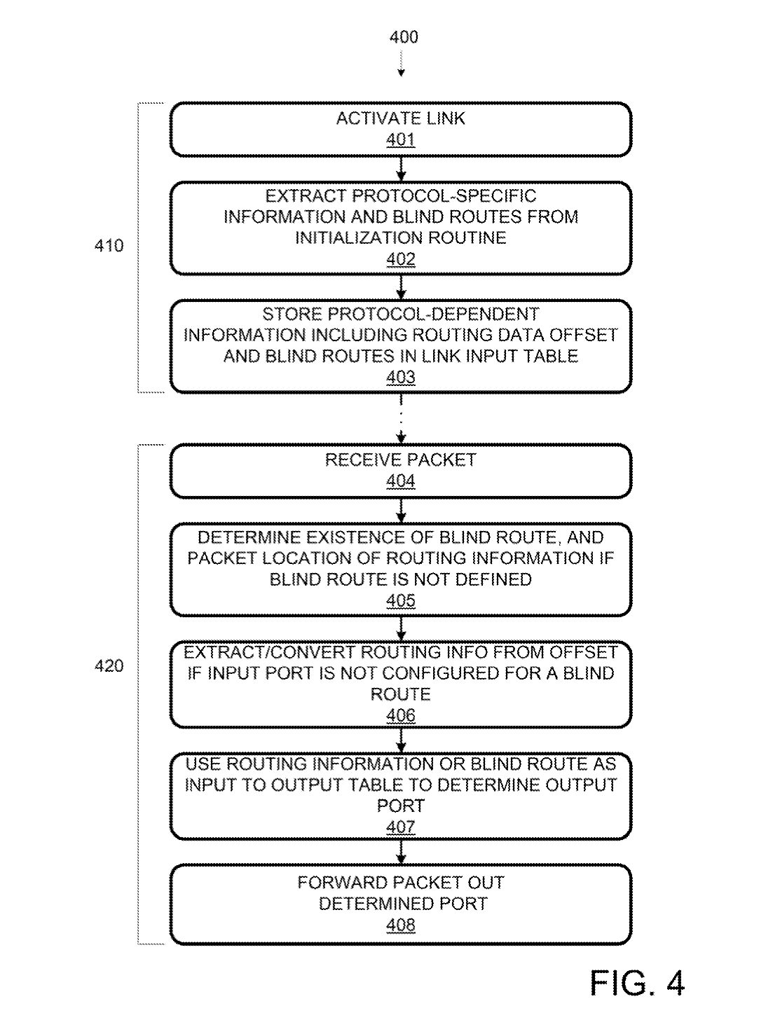

A process 400 implemented by blade system 300 and switch 310 includes a configuration phase 410 and a packet phase 420 as flow charted in FIG. 4. Configuration phase 410 includes a process segment 401 in which a link is activated. This activation may be initiated at a blade or other end node, either as the node is booted or when a link-specific interface of the end node is activated, or at any point during operation. The activation typically involves an exchange of protocol information and establishment of blind routes. Accordingly, protocol-dependent (i.e., protocol-specific) information, and blind route information can be extracted during link initialization at process segment 402. The protocol-dependent information can include an explicit identification of the location at which routing information can be found. Alternatively, the protocol can be identified and the location for the protocol can be “looked up”, e.g., in a table resident on switch 310. Blind route information includes ports that are linked in a blind route so that foreign packets can be routed through the fabric switch without analyzing routing information in the packet. At process segment 403, the extracted information can be stored in input table 331 in terms of a header location, offset and a bit-length following the offset for ports that are processing packets based on protocols, and blind route information for ports that will participate in blind routes. Likewise, conversion information for table 331 can be obtained in explicit form from the header location or inferred from the protocol identity from a table in database 319. This completes a setup phase for process 400.

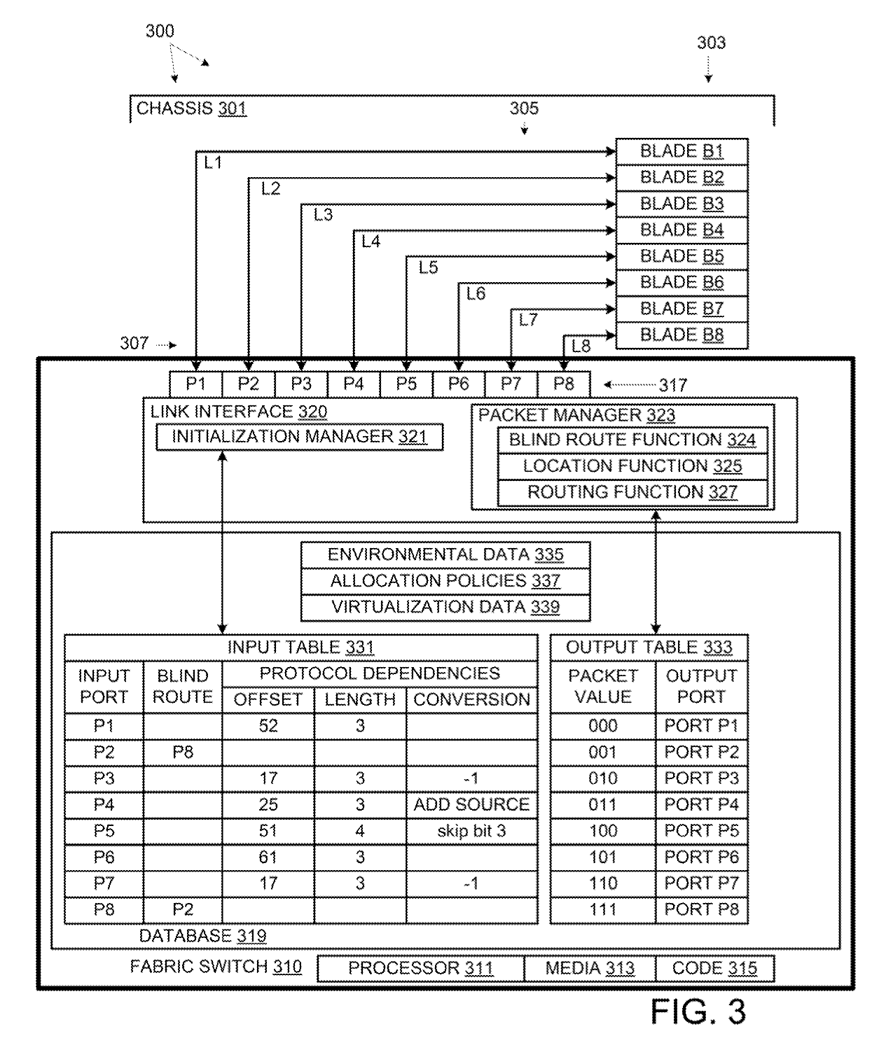

Packet phase 420 of process 400, as flow charted in FIG. 4, begins with receipt of a packet at a port at process segment 404. At process segment 405, blind route function 324 (FIG. 3) determines if a blind route is defined for the port using input table 331, and if a blind route is not defined, location function component 325 (FIG. 3) uses input table 331 to determine the packet location of routing information by looking up the location as a function of the port at which the packet was received. At process segment 406, packet manager 323 extracts the routing information from the determined location of the packet if a blind route is not defined for the input port. Depending on the information in the conversion column of table 331, this routing information can be used directly or converted by routing function component 327. In any case, the resulting value can be input to output table 333 at process segment 407 to select a port for outputting the packet, or the port for outputting the packet may be defined by a blind route. At process segment 408, the packet is forwarded out the selected port.

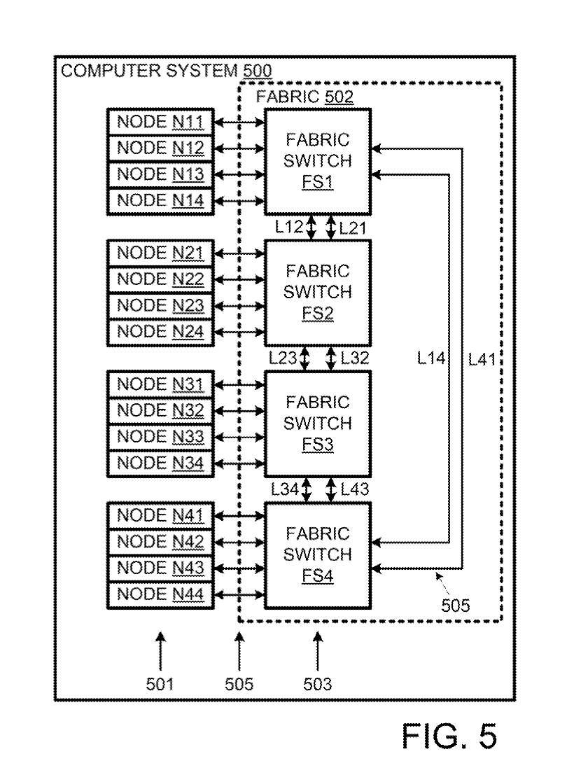

A computer system 500 includes end nodes 501 and fabric 502, as shown in FIG. 5. Fabric 502 includes fabric switches 503 and links 505. End nodes 501 include nodes N11-N44. Fabric switches 503 include fabric switches FS1-FS4. Links 505 include links L11-L43, as well as unlabeled links to end nodes SOIL. Nodes 501 can be of various types with including without limitation processor nodes, network (e.g., Ethernet) switch nodes, storage nodes, memory nodes, and storage network nodes that provide interfacing to mass storage devices. Each fabric switch 503 has eight ports, four of which are shown connected to respective nodes and four of which are shown connected to other fabric switches.

Accordingly, there is a choice of fabric routes between each pair of nodes. In fact, in system 500, there are ten possible fabric routes between each pair of end nodes. For example, node N11 can communicate with node N21: 1) using link L12; 2) using link L21; 3) using the link combination L14, L34, and L23; 4) using the link combination L14, L34, and L32; 5) using the link combination L14, L43, L23, 6) using the link combination L14, L43, and L32; 7) using the link combination L41, L34, and L23; 8) using the link combination L41, L34, and L32; 9) using the link combination L41, L43, and L23; and 10) using the link combination L41, L43, and L32.

In most cases, one of the two more direct routes via links L12 and L21 would be used in communicating between nodes N11 and N21. Of these two, the least utilized could be selected in some cases, links L12 and L21 might be so heavily utilized that communication through one of the other eight routes might be faster and more reliable. So that utilization can be taken into account when a switch, makes routing decisions, each switch FS1-FS4 can monitor utilization at each of its ports and communicate summary information to the other fabric switches. Each fabric switch stores utilization data as environmental data 335 (FIG. 3). Environmental data 335 can also include non-utilization data, such as the average number of retries required to successfully transmit a packet over a link. Such other environmental data can also be used by a switch in making routing determinations.

Switches FS1-FS4 can be configured to treat all packets equally. In general, switches FS1-FS4 will be configured to treat all packets flowing through a blind route equally. Alternatively, for ports not defined for a blind route, switches FS1-FS4 can be programmed with allocation policies 337 (FIG. 3) that cause packets to be treated with different priorities according to source, destination, protocol, content, or other parameter. For example, if there is not enough direct inter-switch bandwidth to handle both real-time and non-real time packets, non-real-time packets can be redirected along an indirect route. Also, some nodes may be associated with more important users; in that case, traffic associated with other users can be sent along slower routes or even dropped to favor the more important users. In an alternative example, traffic is not prioritized.

Other examples providing for inter-switch communications can include different numbers and types of end nodes, different numbers of links associated with nodes, different numbers of inter-switch links, different numbers of ports per switch. Also, the algorithms applied to allocate traffic among alternative routes can vary from those described for system 5(X).

Virtualization data 339 can include data regarding various virtualization schemes including virtual links and virtual channels for ports not defined for a blind route. An implemented virtualization scheme can then be reflected in the allocation policies 337 and environmental data 335. For example, a physical link, e.g., line L12, can be time-multiplexed to serve as several virtual links. Each port connected to the link can have a separate first-in-first-out FIFO buffer for each virtual link, thus defining virtual ports associated with each real fabric switch port. This permits packets sent along different virtual links to progress at different rates depending on virtual link usage.

Virtual channels can be used to handle sessions of packets. For example, it may be desirable to send an acknowledgement packet along the reverse of the route along which the original packet was sent. In other cases, it may be desirable to maintain the same forward and reverse routes for several packets of a “session”. To this end, the packets can be assigned to a virtual channel and the virtual channel can be assigned to a forward and reverse pair of routes. Thus, a series of packets between node N11 and node N31 could all be assigned (using header information) to a given virtual channel; virtualization data 339 can then specify a mapping of the virtual channel to forward and reverse fabric routes.

Note that when fabric 50 is routing packets based on protocols, packets from several input ports may be routed to a single output port. Various switching and buffering mechanisms are provided to synchronize packet delivery, as discussed above. However, when a blind route is defined between two ports, there is a one-to-one mapping from input port to out port, thereby simplifying packet delivery since streams from multiple input ports are not merged into a stream for a single output port.

Fabric switches 100 (FIG. 1), 310 (FIG. 3) and FS1-FS4 (FIG. 5) are, in effect, programmable to handle different fabric protocols and blind routes on a per-port basis. In alternative examples, a switch can be programmed to handle different protocols on a per-virtual-link or per-virtual-channel basis for ports not linked, by a blind route. Virtualization gives the computer system owner great flexibility in terms of configuring and upgrading. For example, during the lifetime of an initial set of end nodes, improved end nodes may have been introduced providing for a new fabric protocol for improved performance, with the new fabric protocol carried by virtual ports and channels. Similarly, blind routes provide flexibility because the switch can be configured to “blind route” packets from new fabric protocols that were not defined or implemented when the switch was designed or manufactured. In system 300, each end node can be replaced at an optimal time (e.g., as it begins to be unreliable or as it becomes a bottleneck) with a new generation end node. The illustrated fabric switches can handle a combination of old and new generation end nodes even though the protocols they support store routing information in different places in the transmitted packets. Furthermore, by defining blind routes, the illustrated fabric switches can handle packet protocols and formats that the fabric switch is unable to route by inspecting the packet.

Unless context indicates otherwise, “port” and “link” can refer to either a real or virtual entity. As used herein, “processor” refers to a hardware entity that can be part of an integrated circuit, a complete integrated circuit, or distributed among plural integrated circuits. Herein, “media” refers to non-transitory, tangible, computer-readable storage media. Unless context indicates that only a software aspect is under consideration, switch components labeled as “managers” or “component” are combinations of software and the hardware used to execute the software.

Herein, a “system” is a set of interacting elements, wherein the elements can be, by way of example and not of limitation, mechanical components, electrical elements, atoms, instructions encoded in storage media, and process' segments. In this specification, related art is discussed for expository purposes. Related art labeled “prior art”, if any, is admitted prior art. Related art not labeled “prior art” is not admitted prior art. The illustrated and other described examples, as well as modifications thereto and variations thereupon are within the scope of the following claims.

What is claimed is:

1. A fabric switch comprising:
ports through which packets are received and forwarded;
a blind route determination function component for determining whether an input port at which a packet was received has a configured blind route to an output port;
a location function component for determining, if the input port does not have a configured blind route, a location of routing information within a received packet containing routing information based at least in part on the input port at which the packet was received; and
a routing function component for determining the output port based at least in part on the routing information or the blind route.

2. A fabric switch as recited in claim 1 further comprising an initialization manager configured to:
activate a link connecting an end node to a port of the switch so as to establish a protocol or blind route to which communications over the link are to conform, and initialize blind routes between ports and generate or adjust the location function to correspond to the use of the protocol at ports if a particular port is not configured for a in route.

3. A fabric switch as recited in claim 2 wherein the ports are real ports.

4. A fabric switch as recited in claim 2 wherein the ports include both real, and virtual ports for ports not initialized for a blind route.

5. A fabric switch as recited in claim 2 wherein the output port is determined as a routing function based at least in part on a virtual channel to which the packet is assigned if the output port is not configured for a blind route.

6. A fabric switch process comprising:
a switch determining whether a blind route has been defined for a first port at which a packet was received as a blind route determination function of the first port;
the switch determining a location of routing information within the packet as a location function of the first port at which the packet was received if a blind route has not been defined for the first port; and
the switch forwarding the packet out to a second port of the switch selected as either a routing function of the routing information, or the blind route.

7. A process as recited in claim 6 further comprising:
before the receiving, engaging in activating a link to the first input port so that communications over the link conform to a first fabric protocol or are routed via the blind route; and
generating or adjusting the location function as a function of the first fabric protocol if the blind route is not used.

8. A process as recited in claim 7 further wherein the ports are real ports.

9. A process as recited in claim 7 wherein the ports are virtual ports for ports not defined for a blind route.

10. A process as recited in claim 7 wherein the determining the output port is a function at least in part of a virtual channel to which the packet is assigned for ports not defined for a blind route.

11. A computer product comprising media encoded with code configured to, when executed by a processor,
implement an input function including determining whether a blind route is defined for an input port at which a packet is received, a packet location as a location function of the input port if a blind route is not defined for the input port, and determine a routing value as a routing function of a packet value extracted from the packet location, or alternatively based on the blind route; and
forward the packet via an output port determined at least in part as a port function of the routing value or a port function of the blind route.

12. A computer product as recited in claim 11 wherein the code is further configured to:
before the receiving, engaging in activating a link to the first input port so that communications over the link conform to a first fabric protocol or are routed via the blind route; and
generating or adjusting the location function as a function of the first fabric protocol if a blind route is not used at the first input port.

13. A computer product as recited in claim 12 wherein the ports are real ports.

14. A computer product as recited in claim 12 wherein the ports are virtual ports for ports for which a in route is not defined.

15. A computer product as recited in claim 12 wherein the determining the output port is a function at least in part of a virtual channel to which the packet is assigned if the output port does not participate in a blind route.
